(19) United States
(12) Patent Application Publication
(10) Pub. No.: US 2003/0233585 A1
(43) Pub. Date: Dec. 18, 2003

(54) System and method for reducing errors during software development

(75) Inventors: David A. Quick, Issaquah, WA (US); Niall L. McDonnell, Seattle, WA (US); Michael J. Moroney, Bellevue, WA (US); Hervey O. Wilson, Bellevue, WA (US); Benjamin S. Wulfe, Bellevue, WA (US)

Correspondence Address: MERCHANT & GOULD, P.O. BOX 2903, MINNEAPOLIS, MN, 55402-0903, US

(73) Assignee: Microsoft Corporation, Redmond, WA (US)

(21) Appl. No.: 10/174,242

(22) Filed: Jun. 17, 2002

(51) Int. Cl. G06F 11/30

(52) U.S. Cl. 713/202; 717/124

(57) ABSTRACT

Described is a system and method for modifying a user-interface by applying a policy that is defined by an external party. The policy modifies the user-interface based on a user's context within the user-interface and prevents the user from performing certain actions. For example, in a software development environment, the user-interface is a user-interface provided by the software development environment and the certain actions that are prevented include adding inappropriate code to an application being developed in the software development environment. The policy may cause the software development environment to disable a menu that is associated with the inappropriate code. The policy may also modify the software development environment in a manner such that the developer is provided with active guidance if undesirable code is added to the application. The active guidance includes text being displayed that explains a reason for preventing the undesirable code within the application.

### BACKGROUND OF THE INVENTION

One of the most time consuming tasks in developing an application is testing the application for problems. Testing ensures that the application operates as expected. Many times software developers inadvertently introduce problems (i.e., software bugs) while developing the application. Many times these problems are introduced because the software developer is inexperienced either in the operating environment or in the software development environment. Other times, the problems may be introduced when the developer is under deadline pressures or fatigued. However, no matter what actually causes the problem, once introduced, fixing the problem is very costly and time consuming.

The earlier a software problem is detected in the development process, the less costly it is to fix. For example, if a problem is detected and fixed before the software module is checked into a software control system, the programmer, who is familiar with the software module and understands the software module, may easily fix the problem. However, once the software module is checked into the software control system, typically, other people, who are not as familiar with the software module, will review the code, fix the problem, and then retest the software module. Therefore, some current software development environments check for proper spelling of components, methods, properties, and the like in order to avoid common software errors. This spell-checking feature prevents many inadvertent errors from being incorporated into the software module.

However, if the software error is not as conspicuous as a misspelled word, these software development environments will not detect the error. The software module will then proceed further in the development process and will typically undergo testing by a software test organization. The software test organization is responsible for detecting problems, isolating problems, correcting problems, and testing the modified software to ensure that correcting the problem did not result in any new problems. While using a software test organization helps in delivering an error-free application, given the competitiveness of software applications, the cost and time delay involved with using a software test organization is less than an ideal solution to the problem.

### SUMMARY OF THE INVENTION

Described is a method for modifying a user-interface by applying a policy that is defined by an external party. The policy modifies the user-interface based on a user's context within the user-interface and prevents the user from performing certain actions. For example, in a software development environment, the user-interface is a user-interface provided by the software development environment and the certain actions that are prevented include adding inappropriate code to an application being developed in the software development environment. The policy may cause the software development environment to disable a menu that is associated with the inappropriate code. The policy may also modify the software development environment in a manner such that the developer is provided with active guidance if undesirable code is added to the application. The active guidance includes text being displayed that explains a reason for preventing the undesirable code within the application.

### BRIEF DESCRIPTION OF THE DRAWINGS

FIG. 1 illustrates an exemplary computing device that may be used in one exemplary embodiment of the present invention.

FIG. 2 is a block diagram illustrating an exemplary framework for practicing the present invention.

FIG. 3 is a block diagram that illustrates modules of an exemplary policy application shown in FIG. 2.

FIG. 4 illustrates salient portions of a policy for restricting the use of user interface functionality in projects with business rules.

FIGS. 5-6 are exemplary screen shots illustrating the effect on the IDE after applying the exemplary policy shown in FIG. 4.

FIG. 7 is a graphical representation illustrating exemplary scopes, or levels, for defining feature constraints on an IDE feature.

FIG. 8 illustrates salient portions of another exemplary policy for restricting the use of user interface functionality in projects with business rules.

FIG. 9 is a flow diagram illustrating an overview of a process for applying a policy to a software development environment in accordance with the present invention.

FIG. 10 is a flowchart illustrating a process for creating a policied project that is suitable for use in the process shown in FIG. 9.

FIG. 11 is a flowchart illustrating a process for loading a policy and performing identification that is suitable for use in the process shown in FIG. 9.

### DETAILED DESCRIPTION OF THE PREFERRED EMBODIMENT

While the inventors of the present invention appreciate that the earlier a software problem is detected, the less costly it is to fix the problem, the inventors further envision a system and method that prevents most software problems from occurring at all or a system and method that at least minimizes the chance of most software problems from occurring. Thus, the present invention is directed at a system and method that helps reduce errors during software development. More specifically, the present invention allows a software architect (e.g., a software project lead) to define a policy that permeates throughout the development of the application. The policy defines proper operating parameters that a developer should adhere to when creating the software modules for the application. The operating parameters change based on the developer's context within the software development environment. These and other aspects of the invention will become apparent to those skilled in the art after reading the following detailed description.

Illustrative Operating Environment

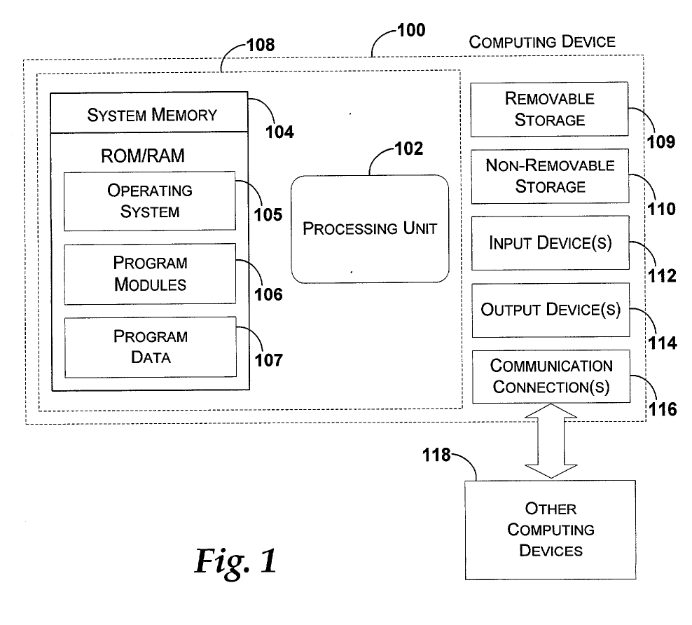

With reference to FIG. 1, one exemplary system for implementing the invention includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more program modules 106, and may include program data 107. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. These devices are well known in the art and need not be discussed at length here.

Computing device 100 may also contain communication connections 116 that allow the device to communicate with other computing devices 118, such as over a network. Communication connections 116 are one example of communication media. Communication media may typically be embodied by computer readable instructions, data structures, program modules, or other data in a modulated data signal, such as a carrier wave or other transport mechanism; and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Design Time Policy Framework

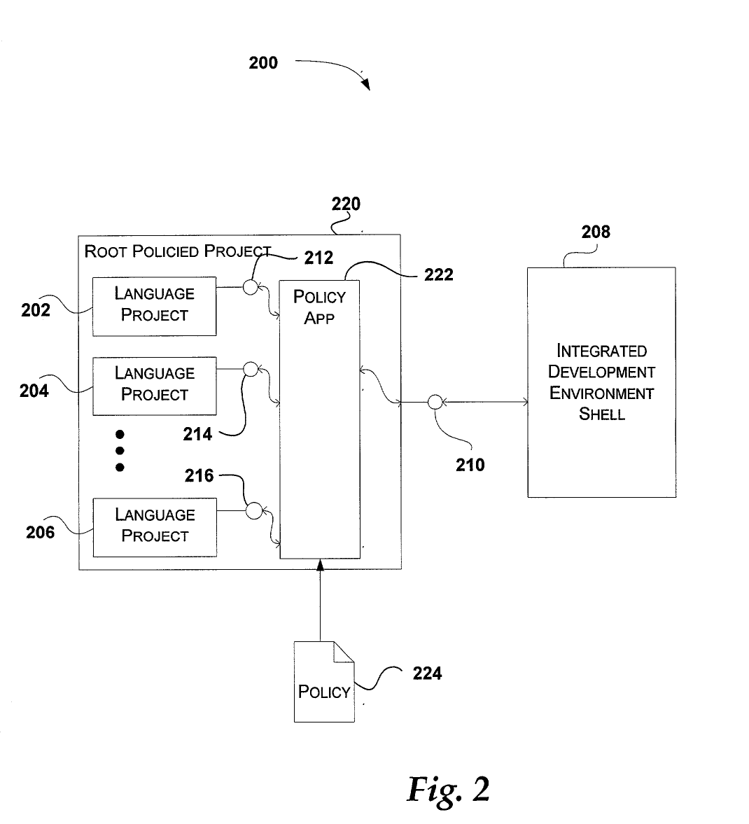

FIG. 2 is a block diagram illustrating an exemplary framework for practicing the present invention. The exemplary framework shown in FIG. 2 is a design-time policy framework 200. The goal in this design-time policy framework 200 is to prevent errors from appearing in a software application that is being developed. The design-time policy framework 200 includes one or more language projects (e.g., language projects 202-206) and an integrated development environment (IDE) shell 208. Language projects 202-206 are development environments for specific programming languages, such as a C programming development environment, a Microsoft Visual Basic programming development environment, and the like. IDE shell 208 allows these various programming developments to co-exist using one user-interface. Thus, the IDE shell 208, in conjunction with the language projects 202-206, provide, what is commonly called a framework that allows the developers to use one user-interface when developing an application, but allows them to write their code in any one or any combination of programming languages associated with language projects 202-206. One exemplary IDE shell 208 is Visual Studio IDE from Microsoft Corporation of Redmond, Wash.

IDE shell 208 provides an interface 210 to language projects 202-206 through language project interfaces 212-216, respectively. In a conventional configuration, interface 210 and language project interfaces 212-216 allow the IDE shell to communicate directly with the language projects 202-206 to execute commands entered through the IDE shell 208. This allows each language project 202-206 to perform its own processing with respect to the command that is entered. The design-time policy framework 200 of the present invention extends the conventional framework by including a policy application 222.

Policy application 222 interfaces with both the IDE shell 208 and the language projects 202-206. Thus, each command entered through the IDE shell 208 is intercepted by policy application 222 before passing through to the desired language project 202-206, and vice versa. Then, in accordance with the present invention, policy application 222 alters the IDE shell 208 based on policy 224. Thus, each project (e.g., policied project 220) developed within this design time framework 200 has a policy 224 associated with it. The policy may specify the types of elements, such as projects, items, references, classes, interfaces, components, and the like, that the IDE shell 208 will support when creating policied project 220. The policy 224 may also define the relationships between each of the elements and may constrain the properties associated with the elements. Policy 224 associated with policied project 222 may physically exist in one or more files. In one embodiment, described in detail below, policy 224 is an XML-based document that includes a schema for specifying the elements and for specifying the rules that control operating parameters within the IDE shell 208 based on a developer's context within the IDE shell 208.

Thus, policy 224 defines a set of rules (e.g., policies) for the policied project 220. As will be described in detail below, policy 224 allows a software architect to modify the development environment. These modifications simplify the developer's environment by filtering out choices and options that are provided by the IDE shell 208. Thus, developers are not able to perform certain functions that the architect has determined are inappropriate for the application being developed. For example, the architect may set a policy that a user-interface element cannot exist within a business logic component because the business logic component must run stand-alone without user intervention. In addition, the software architect may provide reminders to software developers about potential software errors. The reminder may occur when the developer adds code or references to a component that conflicts with policy 224. In this situation, the present invention provides “active guidance” to the software developer who may not be experienced in the programming language, the technology, or the like. This “active guidance” helps prevent these inexperienced developers from making costly errors and helps reduce the training required for the developers to operate using a new technology or a new programming language.

A software architect may design a policy to support various environments. For example, one policy may be an architectural policy that defines an overall structure for an application and identifies elements that are appropriate or inappropriate to use for various parts of the structure. This architectural policy may place context-based constraints on features of the IDE shell 208, such as menus, a toolbox, a property browser, and the like. In another example, policy 224 may be a technology policy that identifies which technologies a corporation may support and identifies appropriate and inappropriate ways to use the technologies in various contexts. In yet another example, policy 224 may be an environmental policy that supports the unique requirements of a particular corporate environment, including shared or predefined resources. Thus, meta-data defined in the policy 224 is extensible so that the policy is modifiable in order to support various policy types for various environments.

The design-time policy framework 200 may be in a distributed computing environment in which the policy application 222 resides on each developer's computer (i.e., computing device 100 shown in FIG. 1) or may exist in a stand-alone environment for a single developer. In addition, if the application is being developed using one programming language, the IDE shell 208 shown in FIG. 2 may represent the software development environment associated with that language project.

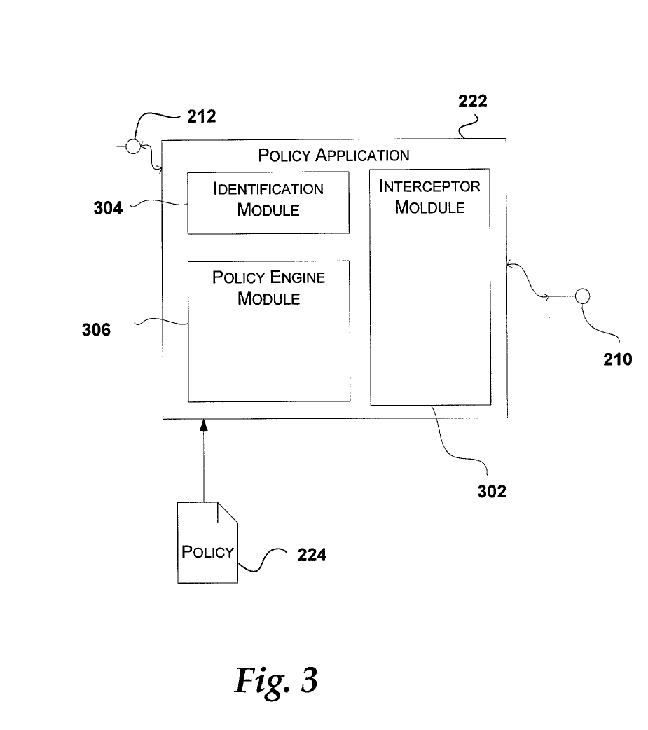

FIG. 3 is a block diagram that illustrates modules of an exemplary policy application 222. The policy application 222 includes an interceptor module 302, an identification module 304, and a rules module 306. Interceptor module 302 is configured to intercept events of the IDE shell through interface 210 and to intercept events from one of the programming languages through the respective programming language interface (e.g., programming language interface 212). Identification mechanism module 304 is configured to exam each item associated with the policied project. Typically, the items are arranged in a hierarchical fashion. When this is the case, the policy application begins at the root of the tree and examines each node in the tree, including all children of each node. This procedure is commonly referred to as “walking” the tree. At each node, the policy application determines whether any projects, project items, classes, or references match elements in policy 224. In one illustrative example, the IDE may expose two objects models. A first object model (e.g., a code model) is for structuring code within the IDE. A second model (e.g., an estensibility model) is for structuring code that is developed to extend various features of the IDE. In this case, the policy application “walks” both of these object models. The policy engine module 306 is configured to apply the policy to the events that were intercepted by interceptor module 302 whenever the event includes one or more elements identified in the policy, as determined by the identification module 304. However, if the event does not include an element identified in the policy, the policy application passes the event through to the, language project, and vice versa.

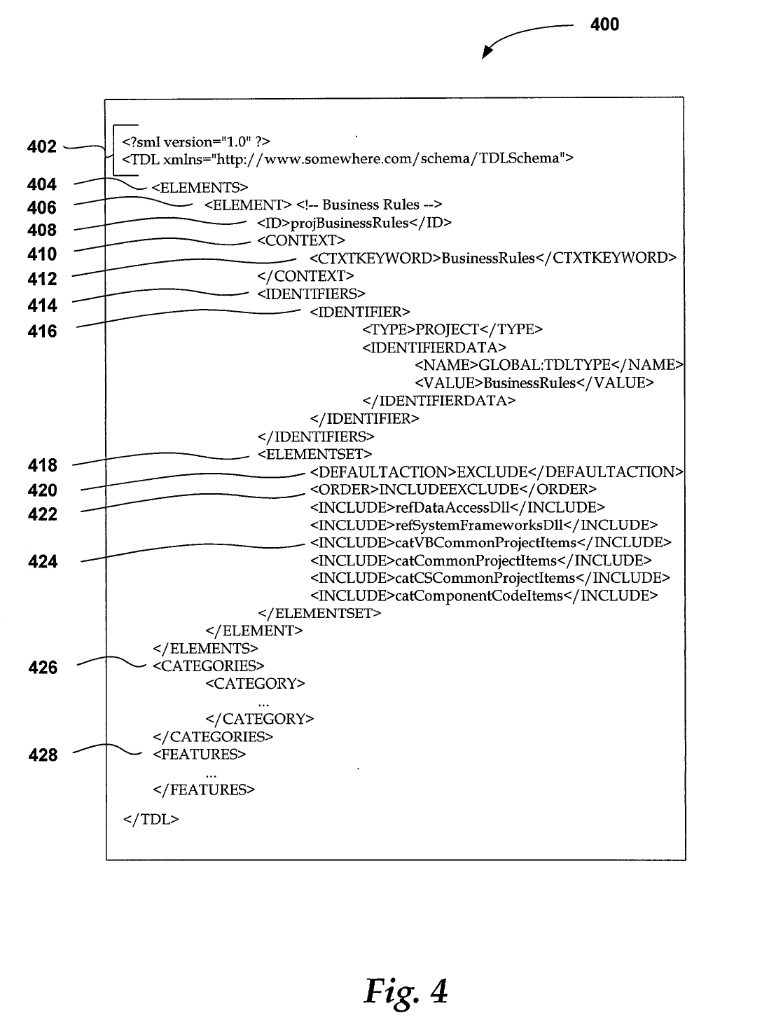

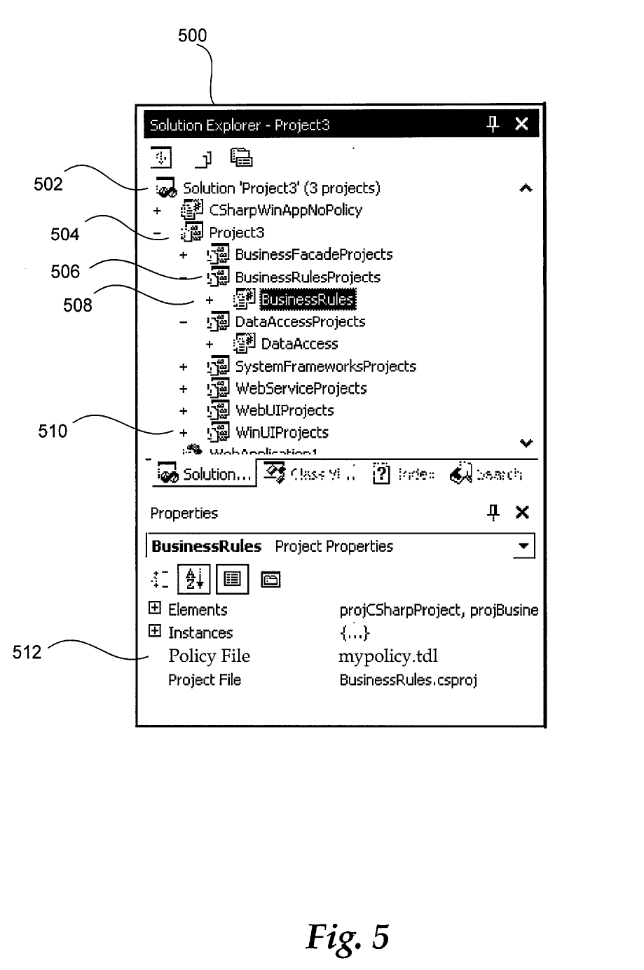

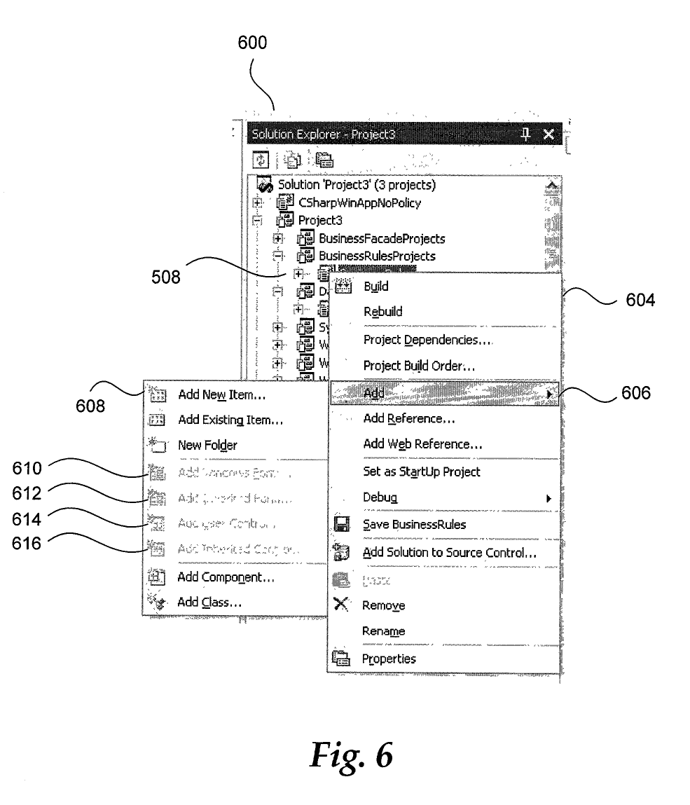

Now, FIG. 4, in conjunction with FIGS. 5-7, illustrates the effect of an exemplary policy 400 (FIG. 4) on the integrated development environment (IDE) in accordance with the present invention. In this example, the architect has defined the policy in a manner such that any project identified as a “Business Rule” type project cannot expose user interface functionality. Thus, FIG. 4 illustrates salient portions of the policy for restricting the use of user interface functionality for projects which contain code that implements business rules. FIGS. 5 and 6 are exemplary screen shots illustrating the effect on the IDE after applying the exemplary policy shown in FIG. 4. However, before describing this effect, terminology used throughout the following discussion is defined to aid in understanding the present invention.

Project is a collection of source files that when compiled creates an executable file. Project tree is a graphical representation of a collection of source files for a project. Solution is a top-most node in a project tree. The solution may have multiple projects. Element is an object that is added to a solution. Elements include projects, project items, references, classes, and controls. Category is an alias for a list of element names, list of categories, or any combination of element names and categories. Categories, thus, reduce repetition when applying different policies to the same group of elements. An element set defines the set of elements allowed as an element's children, either by including them in the element set explicitly, or implicitly allowing them if they are not explicitly excluded. IDE feature is a mechanism that allows manipulation of elements and properties in the IDE. Multiple IDE features may support a single element. For example, a Web Form (i.e., an element) may be added to a project using an Add New Item dialog (i.e., an IDE feature), or the “Web Form” menu item (i.e., another IDE feature). Linked IDE feature is a link between a specific element and an IDE feature. When the element is excluded from a parent element's element set, the linked IDE function associated with the excluded element is automatically disabled. A feature link is an association between a defined element and one or more IDE features, such as menu items, toolbox items, and the like.

FIG. 4 illustrates salient portions of an exemplary policy for restricting the use of user interface functionality for projects with business rules. As will be described, exemplary policy achieves this by excluding the IDE feature from the element set for the element currently selected by the developer (i.e., developer's context) in the IDE. The policy shown in FIG. 4 is defined as a schema 400 in an extensible markup language (XML) based document. Schema 400 includes standard XML syntax, such as declaration 402. In general, schema 400 includes elements that are delimited by angle brackets having a start-tag and a corresponding end-tag. Thus, schema 400 includes an ELEMENT element 406 for defining each element in the policy. All the ELEMENT elements 406 are included within an ELEMENTS element 404. Each ELEMENT element 406 may have an associated ID element 408 that uniquely identifies the type of element being described (e.g., projBusinessRules).

Schema 400 may also include a CTXTKEYWORD element 412 within a CONTEXT element 410 and an IDENTIFIER element 416 within an IDENTIFIER element 414. CTXTKEYWORD element 412 defines a help topic keyword that the IDE uses to create a list of links to help topics that are relevant to the selected element. IDENTIFIER element 416 defines one or more mechanisms that the policy engine uses to determine whether a project element instance matches one or more of the element types defined in the policy. In addition, in accordance with the present invention, schema 400 may further include an ELEMENTSET element 418 for one or more elements (e.g., ELEMENT element 416). As described above, ELEMENTSET element 418 defines the set of elements allowed as an element's children, either by including them in the element set explicitly, or implicitly allowing them if they are not explicitly excluded.

Thus, referring to FIG. 4, ELEMENTSET 418 associated with ELEMENT 406 has a value of “projBusinessRules” associated with ID 408. Within ELEMENTSET 418, DEFAULTACTION tag 420 as a value set to EXCLUDE. This tag/value pair informs the policy engine that no elements are allowed as children for the element associated with ELEMENT 406, unless the children are explicitly allowed. The policy can explicitly allow certain elements by adding an INCLUDE tag within the ELEMENTSET tag. For example, as shown in FIG. 4, several INCLUDE tags (e.g., INCLUDE tag 424) are defined within ELEMENTSET tag 418. One of the INCLUDE tags (e.g., INCLUDE tag 424) has a value of “catVBCommonProjectItems” associated with the tag. When the policy engine processes this tag/value pair, the policy engine determines that any project item that matches any of the elements contained within the CATEGORY tag 426 that has an IDwith a value set to “catVBCommonProjectItems” will be allowed. Therefore, once any element listed as a member of that category is allowed as a child of this element, the rules engine will not modify the IDE's normal behavior. Any element that is not explicitly included as an element or category member is not allowed. The result when this occurs is that the policy engine will modify the IDE as specified in the policy.

Those skilled in the art will appreciate that various schemata may be created to describe elements in the IDE and to describe rules which get applied to the elements in the IDE to modify the IDE. Therefore, the above exemplary schema does not limit the scope of the present invention. In addition, other syntax may be used to describe the elements and rules.

FIGS. 5 and 6 are exemplary screen shots illustrating the interaction of the IDE and the exemplary policy depicted in FIG. 4. FIG. 5 is a screen shot illustrating a solution explorer window 500. The solution explorer window 500 depicts a top-level solution (i.e., Solution ‘Project3’ (3 projects) 502). Below the top-level solution, there are various projects, such as Project3 504. Then, below Project3 504, there are again multiple projects, such as BusinessRulesProjects 506 and WebUIProjects 510. Continuing with the above example, BusinessRulesProjects 506 contains logic for calculating business rules and WebUIProjects contain logic for providing user-interfaces on the Web. The architect responsible for Project 3 504 has determined that the logic in BusinessRulesProject 506 should always run unattended on a server. Therefore, any of the project items (e.g., BusinessRules 508) should not expose any user interface to users of the application. Exposing a user interface is the responsibility of other modules of the application, such as projectitems within WebUIProjects 510. Thus, when BusinessRules 508 is selected in the IDE, policy 512 is displayed. Policy 512 incorporates the exemplary policy 400 depicted in FIG. 4, in addition, to other code not shown in FIG. 4, but readily developed by those skilled in the art after reading the description of the present invention.

Now, turning to FIG. 6, upon right clicking on BusinessRules 508, menu 604 appears. When BusinessRules 508 is right-clicked, interceptor module of the policy application intercepts to the display of each command on the right-click menu and passes the menu on to the C# language project for processing. When the C# program language project returns its response, interceptor module determines that the response does not need modification. Therefore, the response is passed to the IDE without modification. However, upon selecting add 606 from menu 604, policy application disables user interface functionality appearing in sub-menu 608, such as Add Windows Forms 610, Add Inherited Form 612, Add User Control 614, and Add Inherited Control 616. This menu items were disabled because each was linked to an element that did explicitly allow the element in the ELEMENTSET, as described above.

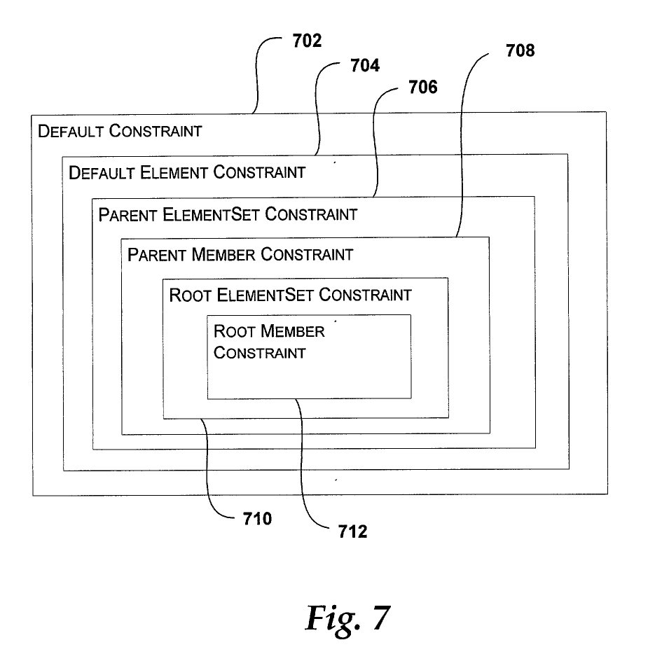

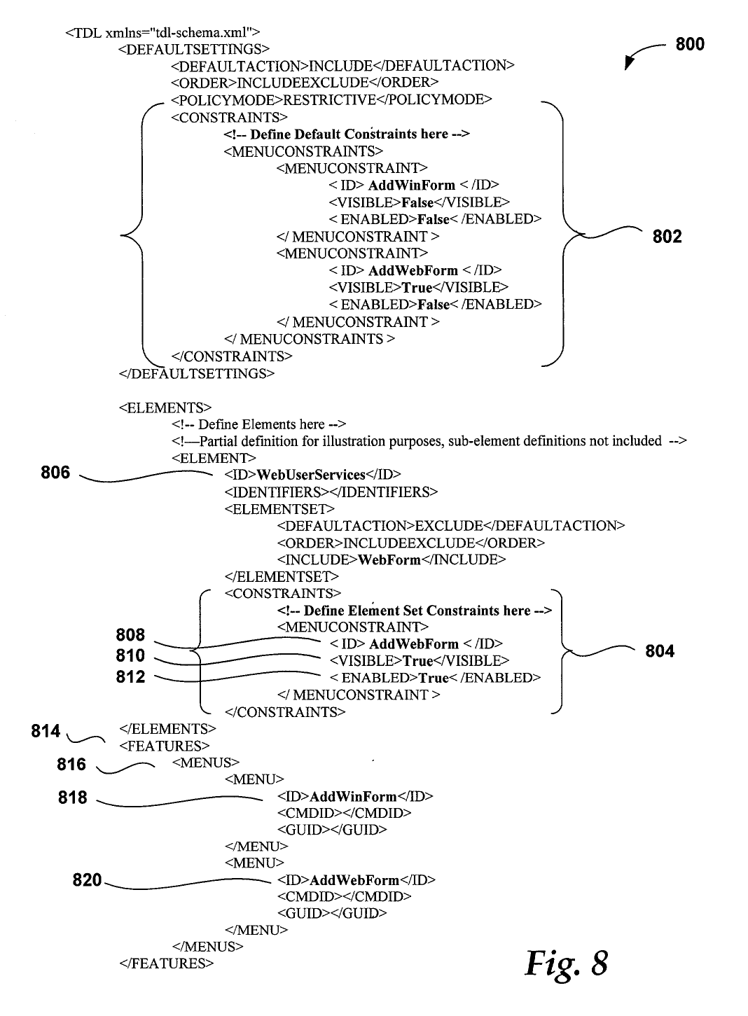

Thus, FIGS. 4-6, in conjunction with the corresponding text, illustrates and describes one embodiment for constraining access to IDE features. In another embodiment, constraining access to IDE features is achieved by applying constraints to a particular IDE feature, which disables the IDE feature. FIGS. 7-9 illustrate the embodiment for constraining access in this manner. However, because disabling the IDE feature in this manner does not prevent a developer from adding the item through other means (e.g., adding code, declaring an object of the disabled type), constraining the IDE feature by excluding it from the corresponding element set (as shown in FIG. 4) provides better protection for errors. Therefore, in general, if an IDE feature has a corresponding element definition, it is desirable to constrain the IDE feature through element set and feature links (FIG. 4), otherwise, the IDE feature may be constrained through feature constraints (FIG. 8). Before describing the salient portions of an exemplary policy 800 that constrains features through feature constraints, the various scopes for these feature constraints are described in conjunction with FIG. 7.

FIG. 7 illustrates exemplary scopes, or levels, for defining feature constraints on an IDE feature. In general, higher-level constraints (e.g., default constraints 702) may be over-ridden by lower-level constraints (e.g., Parent ElementSet Constraints 706). While constraint scopes introduce complexity in the policy application process, the constraint scopes allow an architect to specify common constraints at an appropriate scope level without requiring the architect to specify the same constraints for each element or element property. In addition, constraints allow the architect to define constraints on IDE features without requiring the constraints to be tied to any specific element.

As shown in FIG. 7, the level of constraints, from highest to lowest, includes a default constraint 702, a default element constraint 704, a parent elementset constraint 706, a parent member constraint 708, a root elementset constraint 710, and a root member constraint 712. The default constraint 702 constrains a specified IDE feature beginning where the default constraint is defined in the policy until the default constraint is overridden by a lower level constraint. The default element constraint 704 may constrain or unconstrain an IDE feature or property value for a specific element beginning where the default element constraint 704 is defined in the policy until overridden by a lower level constraint. The parent elementset constraint 706 may constrain or unconstrain an IDE feature or property value for all elements included by a parent element's element set. The parent member constraint 708 may constrain or unconstrain an IDE feature or property value for a specific member element in a parent element's element set. The root elementset constraint 710 may constrain or unconstrain an IDE feature or property value for all elements included by a root parent element's element set. A root parent is a project having its own direct parent. With the root element set constraint 710, an architect may specify a constraint on all objects occurring within a particular project. The root member constraint 712 may constrain or unconstrain an IDE feature or property value for a specific member element in a root parent element's element set. With the root member constraint 712, an architect may specify a constraint on a specific object occurring within a particular project.

FIG. 8 illustrates salient portions of another exemplary policy for restricting the use of user interface functionality in projects with business rules. As briefly mentioned above, this exemplary policy achieves this by applying constraints to the particular IDE feature, thereby disabling the IDE feature. The policy shown in FIG. 8 is defined as a schema 800 in an extensible markup language (XML) based document. Similar to schema 400 in FIG. 4, schema 800 includes standard XML syntax, such as a declaration and elements that are delimited by angle brackets having a start-tag and a corresponding end-tag.

In accordance with the present invention, schema 800 further includes a CONSTRAINTS element 802 that defines various constraints for menus, such as AddWinForm. The scope for CONSTRAINTS element 802 is a default constraint 702 (FIG. 7). As such, CONSTRAINTS element 802 constrains AddWinForm and AddWebForm throughout the policy until overridden. CONSTRAINTS element 802 has a default constraint scope. For this exemplary policy, schema 800 further includes an elementset constraint 804 for a WebUserServices element 806. Elementset constraint 804 includes a menuconstraint for an AddWebForm identifier 808. Therefore, Elementset constraint 804 overrides CONSTRAINTS element 802. The AddWebForm identifier 808 is associated with other tags, such as a VISIBLE tag 810 and an ENABLED tag 812. Those skilled in the art will appreciate that various XML elements may be added to schema 800 without departing from the present invention. In general, schema 800 illustrates one embodiment of salient portions for identifying a policy that is applied by the policy application to modify the IDE based on a developer's context in the IDE.

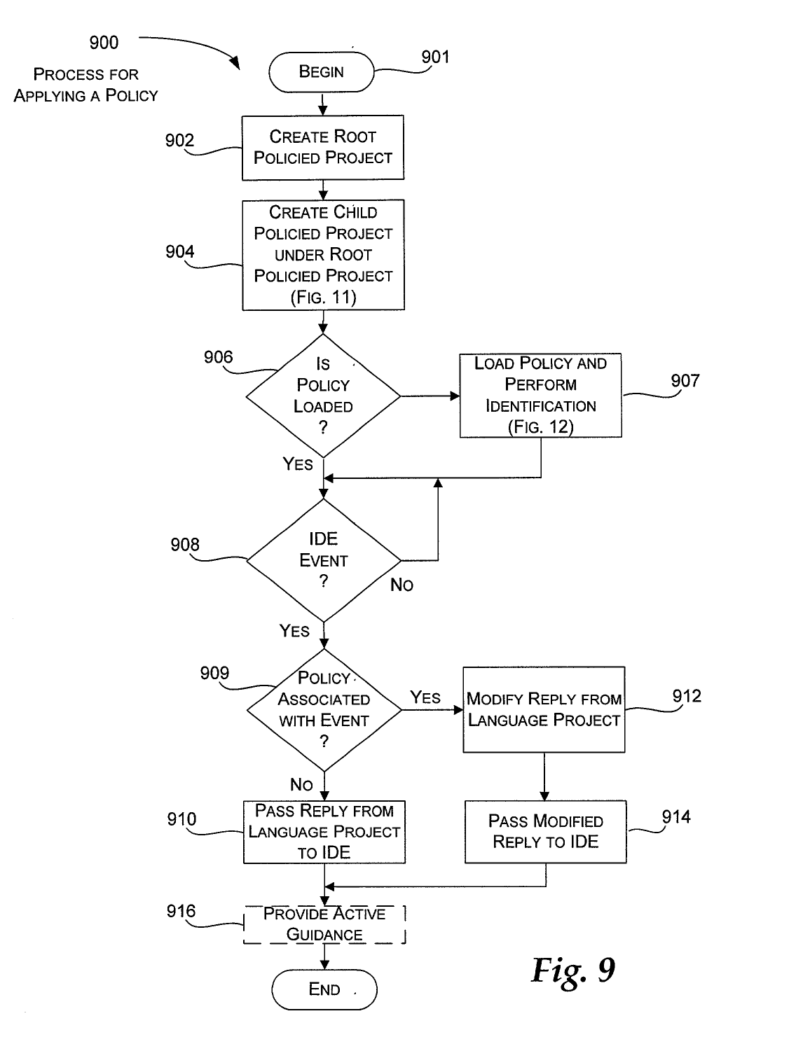

FIG. 9 is a flow diagram illustrating an overview of a process for applying a policy to a software development environment in accordance with the present invention. Process 900 begins at block 901 where an integrated software development environment (IDE) is running. A policy has already been created and has been stored as a file, such as an XML document. Processing continues at block 902.

At block 902, a policied project is created. A policied project is created by associating a policy with a project. The project then becomes a policied project (i.e., a root policied project). In one embodiment, the policy is associated with a project by entering a filename of the policy in the properties window associated with the project. In addition, during creations, the policied project stores a key that identifies the project as a policied project. In one embodiment, the key is a string that is settable via a VSHPROPID_OwnerKey API. Processing continues at block 904.

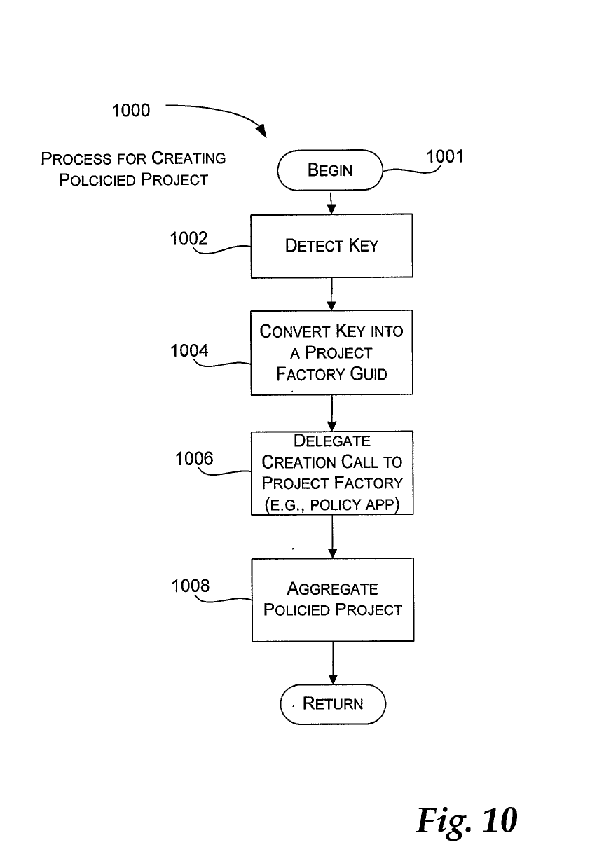

At block 904, a child policied project is created under the root policied project. Briefly, described in detail below in conjunction with FIG. 10, the creation of a policied project directs all method calls and query interfaces on the policied hierarchy to the policy application of the present invention. Processing continues at decision block 906.

At decision block 906, a determination is made whether the associated policy file is already loaded in the IDE. Typically, after performing the identification process on a policy, the identification that is created is cached. Therefore, if a current cache version of the identification associated with the policy exists, processing continues at decision block 908. Otherwise, processing continues at block 907.

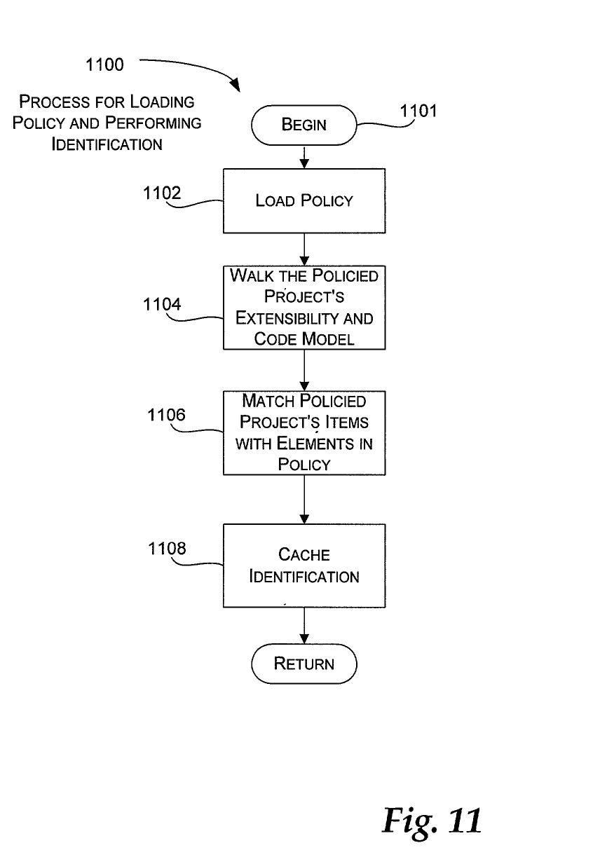

At block 907, the policy file is loaded and an identification process is performed. Briefly, described in detail below in conjunction with FIG. 11, the identification process matches elements defined in the policy file with items in the policied project, such as projects, projectitems, class, references, and the like. Once the identification process is complete, processing continues at decision block 908.

At decision block 908, the policy application waits for an event from the IDE that signals a developer's input. Until such an event occurs, processing continues to check for an event. Those skilled in the art will appreciate that other processing is being performed during this wait condition, but that processing is not of particular interest with respect to the present invention. Once an IDE event occurs, processing continues at decision block 909.

At block 909, a decision is made whether the IDE event has a rule that pertains to the event given the developer's context within the IDE. If the IDE event does not have a rule associated with it, the present invention will pass a reply received from the language project unchanged to the IDE (block 910). Thus, in this instance, the IDE will appear with the same IDE features as a non-policied project. Processing continues at optional block 916.

Returning to decision block 909, if the IDE event does have a rule associated with it, processing continues at block 1012. At block 1012, the process modifies the reply received from the language project after the language project has processed the IDE event. However, those skilled in the art will appreciate that a policy may be applied before send the event to the language project for processing, or the policy may be applied both before sending and after receiving the reply for the language project. Other variations may also be applicable, each one results in a modified reply that is then sent back to the IDE (block 914). Therefore, in this instance, the IDE will appear differently than IDE features appearing in a non-policied project. Processing continues at optional block 916.

At block 916, active guidance may be sent to the IDE for display if the event triggers the policy application to identify code or references that were added to a module that conflict with the policy (i.e., undesirable code). This may occur when a developer cuts and pastes an element that has been disabled through a menu option (e.g., add WinForm) into the software module. When the developer pastes the conflicting element into the Solution Explorer, a designer, or code editor, the identification process identifies the inappropriate code. Active guidance includes reminders that appear in a window. The reminders alert the software developers about potential software errors. In this situation, the present invention provides “active guidance” to the software developer who may not be experienced in the programming language, the technology, or the like. This “active guidance” helps prevent these inexperienced developers from making costly errors and helps reduce the training required for the developers to operate using a new technology or a new programming language.

FIG. 10 is a flowchart illustrating a process for creating a policied project. Process 1000 begins at block 1001, where a call to create a project has occurred. Processing continues at block 1002.

At block 1002, the project detects the key that was stored by the policy engine. The key is then converted into a project factory guid (block 1104). This is the policy engine's project factory guid. Processing continues at block 1006.

At block 1006, the call to create the project is delegated, by the project, to the policy engine's project factory, which creates projects (i.e., policy application 222 shown in FIG. 2). Processing continues at block 1008.

At block 1008, the policy engine's project factory aggregates the child project. In one embodiment, the policy engine calls the Visual Studio IDE IVsOwnedProjectFactory interface's methods to aggregate the child project. In addition, the policy engine returns the controlling project hierarchy to the IDE. Once this is done, the methods and query interface calls to the policied project hierarchy can be intercepted by the policy application. Processing is then complete and returns to FIG. 9.

FIG. 11 is a flowchart illustrating a process for loading a policy and performing identification. Process 1100 starts at block 1101, where it has been determined that a policy that is needed is not currently loaded. Processing continues at block 1102.

At block 1102, a policy is loaded. In one embodiment, the policy is stored in an xml file with an extension .tdl. In illustrative embodiment, in which the IDE is the Visual Studio IDE, project files implement a specific XML schema that supports a UserProperties tag which contains a collection of name/value pairs that expose global information about the project. The name of the xml policy file is the value associated with the “TDLFILE” name within this collection. Processing continues at block 1104.

At block 1104, the policied project's hierarchy is “walked”. Again, in one embodiment, this may include both an, extensibility model and a code model. In this embodiment, the extensibility and code model walk occur using a background thread, rather than a foreground thread. Processing continues at block 1106.

At block 1106, classes, projects, projectitems, references, and the like are matched to elements in the policy using information defined by IDENTIFIER tags within an IDENTIFIERS 414 collection, as shown in the policy defined in FIG. 4. The following is an excerpt from a policy file that illustrates one embodiment for matching elements.

<IDENTIFIER>

<TYPE>PROJECT</TYPE>
<IDENTIFIERDATA>

<NAME>GLOBAL:TDLELEMENTTYPE</NAME>
<VALUE>BusinessRules</VALUE>

</IDENTIFIERDATA>

</IDENTIFIER>

Each IDENTIFIER tag defines the element's instance TYPE (e.g., PROJECT) and other information with an IDENTIFIERDATA collection of name/value pairs that define the individual mechanisms used to identify a selected element instance as matching a given element definition. Each instance type (projects, project items, references, classes, etc,) supports one or more supported identification mechanisms. For example, the instance TYPE “Project”, defined in the excerpt above, supports the NAME “GLOBAL:TDLTYPE”. In the Visual Studio IDE, project files implement a specific XML schema which supports a UserProperties tag which contains a collection of name/value pairs that expose global information about the project. The policy engine can use the value associated with the NAME (e.g., “GLOBAL:TDLTYPE”) as one of the mechanisms for identifying an element of instance TYPE “Project”. In one embodiment, the policy engine must determine that an element instance matches all of the name/value pairs included in the IDENTIFIERDATA collection to identify it as matching the selected element definition. This matching is performed on a foreground thread. Processing in blocks 1104 and 1106 is performed whenever the policy is first loaded and may occur when an event is triggered in the IDE. Typically, the identification process incurs the majority of the time walking the extensibility and code model. Processing continues at block 1108.

At block 1108, the identification is cached. In one embodiment, the identification is cached in per-project files having an extension .eto. Processing is then complete and returns to FIG. 9.

Thus, the present invention as described above, aids in reducing common software development problems by allowing software architects to define a relevant policy for the application. Thus, individual developers do not need to necessarily understand all of the issues in advance or need to recognize the problem themselves. In addition, the policy created for one application may be used in several other applications with little if any modifications to the policy. While the above embodiment describes the operation of the present invention in a software development environment, one skilled in the art will appreciate that the present invention may be used to apply a policy to manipulate a user-interface in other types of environments based on rules defined by an external individual or organization.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A computer-implemented method for modifying a user-interface, comprising:
applying a policy that modifies a user-interface based on a user's context within the user-interface, the policy preventing the user from performing certain actions as determined by the policy.

2. The computer-implemented method of claim 1, wherein the user-interface is associated with a software development environment and the certain actions includes adding inappropriate code to an application being developed in the software development environment, the inappropriate code being determined by the policy.

3. The computer-implemented method of claim 2, wherein the policy modifies the software development environment by a user interface mechanism that is associated with the inappropriate code.

4. The computer-implemented method of claim 3, wherein the user interface mechanism includes a menu that is disabled.

5. The computer-implemented method of claim 3, wherein the policy modifies the software development environment in a manner such that the developer is provided with active guidance if undesirable code is added to the application.

6. The computer-implemented method of claim 5, wherein the active guidance includes a window displaying text that explains a rule within the policy that is associated with the undesirable code.

7. The computer-implemented method of claim 3, wherein the policy identifies a plurality of elements associated with the software development environment, identifies a plurality of rules, and define relationships between the plurality of elements and the plurality of rules.

8. The computer-implemented method of claim 7, wherein one of the plurality of rules includes a constraint on an IDE feature of the software development environment.

9. The computer-implemented method of claim 8, wherein the constraint has one of a plurality of scopes based on a-location of the constraint within the policy.

10. The computer-implemented method of claim 7, wherein one of the plurality of rules includes a feature link that excludes an IDE feature from an element set associated with one of the plurality of elements.

11. The computer-implemented method of claim 1, wherein the policy includes one or more files.

12. The computer-implemented method of claim 1, wherein the policy includes a document based on an extensible mark-up language.

13. A computer-readable medium having computer-executable components with instructions for reducing errors during software development, comprising:
a development environment configured to provide a user-interface to a developer when developing code for an application;
one or more language projects, each language project configured to support an associated programming language; and
a policy application configured to intercept communication between the development environment and the one or more language projects and configured to modify the development environment based on a policy and a developer's context within the development environment.

14. The computer-readable medium of claim 13, wherein the policy application is configured to intercept communication by performing a method comprising:
detecting a key that is assigned to a policied project when created, the policied project being responsible for managing code for the application;
converting the key into a project factory guid, the project factory guid being associed with a policy engine project factor;
delegating a creation call for a project to the policy engine project factory; and
aggregating the project so that calls to methods of the project pass through the policyapplication.

15. A method for reducing errors during software development, the method comprising:
receiving an input from the software development environment;
passing the input to a programming development environment, the programming development environment being associated with a programming language;
upon receiving a response from the programming development environment, determining whether the input has a rule defined in the policy that applies when the input is received from a current context within the software development environment;
if so, modifying the response based on the policy; and
transmitting the modified response to the software development environment, the modified response affecting a user-interface of the software development environment.

16. The method of claim 15, wherein the modified response affects the user-interface by disabling one of a menu, a toolbox item, and a property within a property browser.

17. The method of claim 15, wherein the policy is defined in an XML-based document.

18. The method of claim 15, wherein the modified response affects the user-interface by displaying text that explains a reason for disallowing an action associated with the input.

19. A computer-readable medium encoded with a data structure, comprising:
a first field for identifying an element associated with a software development project; and
a second field for identifying a rule for manipulating a software development environment when the element is being selected within the software development environment, the software development project being developed using the software development environment.

20. The computer-readable medium of claim 19, wherein the first field includes at least one sub-field for identifying a property associated with the element.

21. The computer-readable medium of claim 19, further comprising a third field for grouping at least two of the first fields.

22. The computer-readable medium of claim 19, wherein the rule disables a feature within the software development environment.

23. The computer-readable medium of claim 22, wherein the feature includes one of a menu, a toolbox item, and a property within a property browser.

24. The computer-readable medium of claim 19, wherein the rule includes a reason for disallowing the element being selected from being added to the software development project, the reason appearing within a window of the software development environment.

25. The computer-readable medium of claim 19, wherein the data structure is in an XML-based format.

26. A system for modifying a user-interface, comprising:
a processor,
a memory into which a plurality of instructions are loaded, the plurality of instructions performing a method comprising:
applying a policy that modifies a user-interface based on a user's context within the user-interface, the policy preventing the user from performing certain actions as determined by the policy.

27. The system of claim 26, wherein the user-interface is associated with a software development environment and the certain actions includes adding inappropriate code to an application being developed in the software development environment, the inappropriate code being determined by the policy.

28. The system of claim 27, wherein the policy modifies the software development environment by a user interface mechanism that is associated with the inappropriate code.

29. The system of claim 28, wherein the user interface mechanism includes a menu that is disabled.

30. The system of claim 28, wherein the policy modifies the software development environment in a manner such that the developer is provided with active guidance if undesirable code is added to the application.
